(19) United States
(12) Patent Application Publication
(10) Pub. No.: US 2026/0072811 A1
(43) Pub. Date: Mar. 12, 2026

(54) OPTIMIZED REGRESSION TESTING THROUGH DEPENDENCY GRAPH ANALYSIS AND SELECTIVE TEST EXECUTION

(71) Applicant: Sanjay Pillay, Austin, TX (US)

(72) Inventor: Sanjay Pillay, Austin, TX (US)

(21) Appl. No.: 19/253,714

(22) Filed: Jun. 27, 2025

Related U.S. Application Data
(60) Provisional application No. 63/665,252, filed on Jun. 27, 2024.

(51) Int. Cl. G06F 11/3668

(52) U.S. Cl. CPC G06F 11/3676

(57) ABSTRACT

A method is provided for optimizing regression testing in a software development environment. The method includes analyzing source code to create a structural dependency graph that maps dependencies between code elements; identifying changes in the source code between a current version and a previous version; mapping the identified changes onto the structural dependency graph to determine affected code elements; selecting a subset of regression tests based on the affected code elements identified in the dependency graph; and executing the selected subset of regression tests to validate the changes in the source code.

### CROSS-REFERENCE TO RELATED APPLICATIONS

This application claims the benefit of U.S. provisional application No. 63/665,252 filed Jun. 27, 2024, having the same title and the same inventor, and which is incorporated herein by reference in its entirety.

### FIELD OF THE DISCLOSURE

The present application relates generally to software testing and quality assurance, and more specifically to software regression testing.

### BACKGROUND OF THE DISCLOSURE

Regression testing is a crucial component of the software development lifecycle and seeks to ensure that new changes or additions do not negatively affect the existing functionality of the software. This process preserves the integrity and stability of applications by detecting unintended consequences of code changes early in development. By providing a safety net, regression testing allows developers to evolve the software confidently, supporting incremental development and continuous improvement. It verifies that new code integrates smoothly with existing systems, maintaining high standards of software quality and reliability.

Modern regression testing often involves automation, seamlessly integrating into development pipelines to offer immediate feedback and enable rapid iterations. This practice is vital for continuous integration and continuous deployment (CI/CD) processes, allowing faster release cycles and more reliable updates. Additionally, early detection of issues through regression testing is cost-effective, saving time and resources by avoiding the need for expensive fixes after deployment. It also reduces the risk of software failures in production, ensuring consistent user experiences and building customer trust.

Regression testing addresses the challenges of complex dependencies and long-term maintenance in software systems. It enhances software stability, quality, and reliability, supporting modern development practices and ultimately leading to cost savings and higher customer satisfaction. By integrating effective regression testing strategies, development teams can ensure that their software remains robust and dependable as it evolves and grows.

### BRIEF DESCRIPTION OF THE DRAWINGS

FIG. 1 is flowchart illustrating a method for optimizing regression testing in a software development environment.

FIG. 2 is a block diagram illustrating an exemplary system architecture for optimizing regression test selection, comprising components for token differencing, dependency analysis, test selection, and execution orchestration.

FIG. 3 is a schematic diagram illustrating a token differencing pipeline including a token database, a hash-based diffing window, and context-aware change classification.

FIG. 4 is a block diagram illustrating token metadata, differencing, and classification into cosmetic and substantive changes via a context-aware diffing window and hash-based differencing module.

FIG. 5 is a schematic diagram illustrating a regression dependency graph comprising a plurality of code elements, including a modified node and directed edges indicating interdependencies. Dashed test regions represent regression test cases associated with specific code elements and show how a change to node B propagates through dependent components.

FIG. 6 is a diagram of a regression dependency graph showing structural relationships between code elements and corresponding regression test coverage areas. The modified node is highlighted, and arrows depict dependency propagation to downstream nodes. Labeled annotations illustrate test coverage overlap and the triggering of test re-execution upon changes.

FIG. 7 is a schematic block diagram illustrating the use of multiple risk features as input to a risk scoring model, which produces ranked regression test outputs.

FIG. 8 is a flowchart showing the computation of a risk score for affected code elements based on factors such as change frequency and dependency centrality, resulting in prioritized test selection.

### SUMMARY OF THE DISCLOSURE

In one aspect, a method is provided for optimizing regression testing in a software development environment. The method comprises analyzing source code to create a structural dependency graph that maps dependencies between code elements; identifying changes in the source code between a current version and a previous version; mapping the identified changes onto the structural dependency graph to determine affected code elements; selecting a subset of regression tests based on the affected code elements identified in the dependency graph; and executing the selected subset of regression tests to validate the changes in the source code.

In another aspect, a system is provided for optimizing regression testing in a software development environment. The system comprises a code analysis module configured to parse source code and create a structural dependency graph mapping dependencies between code elements; a change identification module configured to identify changes in the source code between a current version and a previous version; a test selection module configured to map identified changes onto the structural dependency graph and determine a subset of regression tests based on affected code elements; and a test execution module configured to execute the selected subset of regression tests.

In a further aspect, a non-transitory computer-readable medium is provided. The medium has stored therein instructions that, when executed by a processor, cause the processor to perform a method for optimizing regression testing in a software development environment, the method comprising (a) parsing source code to create a structural dependency graph mapping dependencies between code elements; (b) identifying changes in the source code between a current version and a previous version; (c) mapping the identified changes onto the structural dependency graph to determine affected code elements; (d) selecting a subset of regression tests based on the affected code elements identified in the dependency graph; and (e) executing the selected subset of regression tests to validate the changes in the source code.

In still another aspect, a method for dependency-based test selection in a software testing environment is provided. The method comprises generating an abstract syntax tree (AST) from source code; using the AST to create a dependency graph that maps relationships between code elements; detecting changes in the source code and mapping the changes onto the dependency graph; analyzing historical test coverage data to determine which regression tests cover the affected code elements; and selecting and executing the regression tests that cover the affected code elements.

In yet another aspect, a method for cost-efficient regression testing in a cloud-based environment is provided. The method comprises creating a dependency graph from source code to map dependencies between code elements; identifying changes in the source code and mapping these changes onto the dependency graph; selecting a subset of regression tests based on the affected code elements identified in the dependency graph; provisioning cloud resources to execute the selected subset of regression tests; and dynamically scaling cloud resources based on the computational requirements of the selected regression tests to optimize cost efficiency.

In another aspect, a system is provided for selective regression test execution. The system comprises a dependency analysis module configured to create a dependency graph from source code; a change detection module configured to identify changes in the source code and map these changes onto the dependency graph; a test coverage analysis module configured to use historical test coverage data to determine which regression tests cover the affected code elements; and a test execution module configured to execute the selected regression tests that cover the affected code elements.

In a further aspect, an automated regression testing optimization tool is provided. The tool comprises a parser for analyzing source code to generate a structural dependency graph; a change tracker for identifying and mapping changes in the source code onto the dependency graph; a selector for determining a subset of regression tests based on the mapped changes; an executor for running the selected regression tests; and a feedback system for collecting test execution results and refining the test selection process.

In another aspect, a computer-implemented method for optimizing software testing is provided. The method comprises analyzing source code to identify structural relationships between code elements; detecting changes between a current version and a prior version of the source code; determining a set of affected code elements based on the detected changes and the structural relationships; selecting a subset of available tests that correspond to the affected code elements; and executing the selected subset of tests.

In still another aspect, a regression testing orchestration apparatus is provided. The apparatus comprises a token differencing engine configured to compare a current version of source code to a prior version and generate a list of changed code tokens; a dependency analyzer configured to receive the list of changed tokens and identify affected code elements based on stored structural relationships; a test selector configured to select a subset of regression tests corresponding to the affected code elements; and a reporting module configured to output the selected tests and their associated metadata for execution in a software testing environment.

In yet another aspect, a system is provided for optimizing software test selection. The system comprises a processor; and memory storing instructions that, when executed by the processor, cause the system to identify changes in source code, determine affected portions of the code based on structural dependencies, and select tests relevant to the affected portions.

### DETAILED DESCRIPTION

### Definitions

As used herein, the following terms shall have the meanings set forth below, unless otherwise indicated.

Abstract Syntax Tree (AST): A hierarchical tree structure generated by parsing source code, wherein each node represents a syntactic construct in the programming language, such as function declarations, control statements, or expressions. The AST serves as an intermediate representation used for constructing structural dependency graphs.

Affected Code Elements: Code elements (e.g., functions, classes, variables) determined to be impacted directly or indirectly by changes in the source code. These elements are identified by mapping the changes onto a structural dependency graph.

CI/CD Pipeline: A continuous integration and continuous deployment (CI/CD) pipeline refers to an automated software delivery process that integrates code changes into a shared repository and deploys them to production or staging environments. The pipeline includes stages such as build, test, and deployment, and may invoke regression tests upon each commit or merge.

Code Element: An individual component of source code, such as a function, method, class, variable, or module, that can participate in dependency relationships and be subject to analysis during regression testing.

Context Identifier: A unique identifier associated with a token or code element that encodes its fully qualified scope, such as a namespace, class, or method. This identifier is used to match changes and dependencies within the token database and dependency graph, enabling precise localization of impacted regions.

Dependency Graph: A data structure representing dependencies between code elements. Nodes in the graph correspond to individual code elements, while edges represent relationships such as function calls, data access, control flow, or inheritance. The graph may include both direct and transitive dependencies.

Direct Dependency: A relationship between two code elements where one directly uses, calls, or references the other. For example, if function A calls function B, function A has a direct dependency on function B.

Historical Test Coverage Data: Data collected from previous test executions that indicates which portions of the source code were exercised during those tests. This data is used to determine the relevance of specific tests to newly affected code elements.

Indirect (Transitive) Dependency: A chain of dependencies between code elements, where one element depends on another through one or more intermediate dependencies. For example, if function A calls function B and function B calls function C, function A is indirectly dependent on function C.

Non-Functional Edit: A modification to source code that does not alter program logic or behavior, such as formatting changes, comments, or whitespace alterations. These edits may be excluded from triggering regression tests.

Regression Testing: A form of software testing intended to verify that changes to a codebase (including additions, deletions, or modifications) do not introduce new defects or break existing functionality.

Risk Score: A dynamically computed numerical value assigned to a token or code element indicating the relative likelihood that undetected defects within that element may result in user-visible failures. Risk score components may include metrics such as change frequency, defect density, cyclomatic complexity, and dependency centrality.

Selective Test Execution: The process of executing only a targeted subset of regression tests that are relevant to recent changes in the code, based on dependency analysis and historical test coverage.

Structural Dependency Graph: A graph-based data structure representing semantic relationships between code elements such as functions, classes, and modules. Nodes correspond to code elements, and edges encode dependencies such as function calls, variable references, and inheritance. The dependency graph is used to determine which code regions are impacted by changes and to drive the selection of relevant regression tests.

Subset of Regression Tests: A group of tests selected from a larger regression test suite, chosen based on their relevance to the affected code elements identified through dependency analysis.

Token: A syntactic unit generated during lexical analysis of source code, representing elements such as keywords, operators, identifiers, literals, or comments. Tokens form the basis of abstract syntax trees and are tracked for coverage and change detection.

Token Database: A persistent, versioned data store comprising normalized tokens extracted from source code via lexical and syntactic analysis. Each token record includes metadata such as syntactic scope, semantic role, file path, and commit identifier. The token database supports granular change detection, semantic differencing, and multi-language normalization for use in regression test optimization workflows.

Version Control System (VCS): A software system (e.g., Git, SVN, Mercurial) used to manage changes to source code over time. The system provides commit histories, diff tools, and metadata that facilitate identification of code changes.

“Token Database” vs. “Structural Dependency Graph”: As used herein, the terms “token database” and “structural dependency graph” refer to distinct but complementary components of the regression testing system.

The token database is a versioned, persistent store of semantically normalized code tokens generated from source code files during lexical and syntactic analysis. Each token record may include metadata such as its lexical content, syntactic scope, semantic role, associated file path, and version control commit identifier. The token database is optimized for set-based differencing, historical comparison, and change impact analysis at the token level across multiple versions and languages.

In contrast, the structural dependency graph is a dynamically constructed, in-memory or persisted graph data structure that represents semantic and structural relationships between code elements (e.g., functions, classes, variables, modules). Nodes in the graph correspond to code elements, while edges represent dependencies such as function calls, variable usage, inheritance relationships, or module imports. The dependency graph is updated as the source code evolves, using input from the token database and version control system, and serves as the basis for identifying affected code regions and selecting relevant regression tests.

While both the token database and the structural dependency graph operate on representations of source code, the former is concerned with fine-grained syntactic units and version-tracking, whereas the latter encodes inter-element relationships necessary for impact propagation and test selection.

Despite being an important component of the software development lifecycle, current implementations of regression testing in software development are plagued by inefficiencies and high costs, especially when applied to widely used software that has already gone through several versions. These costs and inefficiencies are associated with the typical need to run large numbers of tests on each additional modification to the software. The need to run a large number of tests in regression analysis is an artifact of the software development and regression testing process. This process has the effect of requiring a high testing frequency, while adding a net number of tests with each version of the software produced.

Incremental development methodologies, such as agile and iterative development, significantly increase the frequency of testing due to their nature of developing and releasing software in small, manageable increments. Each incremental change, whether it is a new feature, a bug fix, or an enhancement, needs to be thoroughly tested against the entire system to ensure seamless integration. This ensures that the new changes do not disrupt existing functionality and that the software remains stable. As these increments are often small and frequent, testing must be performed continually, leading to a higher overall frequency of testing.

Continuous Integration (CI) and Continuous Deployment (CD) practices further amplify the need for frequent testing. CI/CD pipelines are designed to automatically integrate and deploy code changes as they are made, often multiple times a day. To catch issues early and ensure that each change does not introduce new defects, automated tests are run continuously throughout the development process. This approach not only accelerates the development cycle but also improves code quality by providing immediate feedback to developers. Consequently, the combination of incremental development and CI/CD practices results in a continuous and frequent testing regime, which is essential for maintaining the reliability and performance of the software.

Several factors contribute to the net increase in the number of tests that need to be run with modifications to the software to ensure comprehensive coverage and to maintain software quality.

In order to ensure stability, every new change in the software must be tested against the entire codebase. This thorough testing approach ensures that new features do not introduce bugs or regressions, and that the expected functionality of the software is maintained. Given the complex interdependencies within software systems, changes in one part of the code may have unintended impacts on other parts. Comprehensive testing is essential to catch these potential issues early. This need for extensive coverage means that, with every new version of the software, the number of tests increases to cover both new changes and existing functionalities.

As software evolves, the test suite grows progressively larger due to the accumulation of tests for new features and bug fixes. Every new feature added to the software comes with new tests to verify its correct implementation. Similarly, fixing bugs often involves creating tests to ensure those issues do not recur. Over time, these new tests are added to the existing suite, which continues to expand. Additionally, legacy tests, which were created to verify older features or bug fixes, often remain part of the suite to ensure ongoing functionality. This continuous accumulation and retention of tests contributes to a significant increase in the total number of tests that need to be run with each new software version.

Running extensive regression tests frequently incurs significant costs due to the attendant consumption of computational resources. Each test run utilizes CPU hours, which directly translates into financial expenses. As software development increasingly adopts agile methodologies and continuous integration/continuous deployment (CI/CD) pipelines, the frequency of test executions has surged, amplifying these costs. Regression testing involves executing a vast number of test cases to ensure that recent code changes do not introduce new bugs or break existing functionality. Each of these tests requires CPU time, and the cumulative effect of running thousands or even tens of thousands of tests typically leads to substantial CPU usage. In order to speed up the testing process, tests are often run in parallel, which requires provisioning multiple virtual machines or containers simultaneously, increasing the demand for CPU resources and further escalating costs. Comprehensive regression tests can take a considerable amount of time to complete, especially for large and complex codebases, leading to prolonged test runs and higher expenses.

Cloud platforms such as AWS, which are commonly used in regression testing, operate on a pay-per-use model, where users are billed based on the amount of computational resources they consume. Hence, users are typically charged for CPU hours, memory usage, and other resources. Frequent and extensive test runs result in substantial usage, leading to high costs. In environments where multiple developers are committing code changes daily, regression tests may need to be executed multiple times a day, leading to escalating monthly bills. Additionally, costs associated with data storage for test results, data transfer fees, and the use of additional cloud services such as load balancers and networking infrastructure contribute to the overall expense.

It will be appreciated from the foregoing that there is a significant need in the art to reduce the number of tests required to be run in regression analysis. Cost efficiency is a primary concern, as running extensive regression tests can be expensive, especially when using cloud platforms that charge based on computational resource usage. Each test consumes CPU hours, memory, and storage, leading to substantial costs when performed frequently. By reducing the number of tests, organizations can significantly lower these expenses, making the testing process more economically viable.

Time savings is another important consideration. Regression testing can be time-consuming, particularly for large and complex codebases. Running extensive test suites delays feedback to developers and slows down the development process. Conversely, minimizing the number of tests required accelerates the testing process, allowing for quicker identification of issues and more rapid iteration and development cycles. This optimization also reduces the strain on computational resources, freeing up CPU, memory, and storage for other critical tasks, which is essential in environments with limited resources.

Furthermore, reducing the number of tests required in regression analysis improves development efficiency. Developers receive faster feedback on their code changes, enabling them to address issues promptly and spend more time on coding and feature development. This streamlined workflow leads to a more efficient development process. Additionally, maintaining a large suite of regression tests requires substantial effort, as tests need to be updated, refactored, and maintained as the codebase evolves. By minimizing the number of tests required, the maintenance burden is reduced, allowing QA teams to focus on creating high-quality tests that provide maximum coverage with minimal redundancy.

A smaller, well-targeted set of tests also tends to be more reliable. Large test suites may contain redundant or overlapping tests, leading to false positives and false negatives. By focusing on essential tests, the overall reliability of the testing process is improved, providing more accurate and meaningful results. Minimizing the number of tests also allows for the prioritization of the most critical and impactful tests, ensuring that the most important functionalities are thoroughly tested and reducing the risk of critical bugs slipping through the cracks.

It has now been found that the foregoing need to reduce the number of tests run in regression analysis may be met, and the foregoing benefits achieved, with the systems and methodologies disclosed herein.

In particular, systems and methodologies are provided herein which address the challenges of extensive regression testing by implementing dependency graph analysis to minimize the number of tests required. This approach ensures that only the most relevant tests are executed, significantly reducing the computational resources and time required for testing, and thereby cutting costs. By mapping out structural dependencies within the code, these systems and methodologies can help identify which parts of the software are affected by specific changes. This allows for targeted testing of these areas, focusing on those likely to be impacted by recent modifications.

The selective testing afforded by the systems and methodologies disclosed herein may greatly reduce cost and may significantly enhance efficiency compared to conventional regression analytics tools. In particular, by reducing the number of tests required to a manageable subset, dramatic reductions in CPU hours and associated expenses may be realized, particularly on cloud platforms such as AWS. In some applications, the number of tests required may be reduced by a factor of ten or more.

Another key benefit of some of the systems and methodologies disclosed herein is the improved development efficiency they provide. In particular, the systems and methodologies disclosed herein provide faster feedback to developers, enabling them to identify and fix issues promptly. This acceleration in the testing process means that developers spend less time waiting for test results and more time on productive development work. Additionally, reducing testing time decreases the likelihood of code integration conflicts, especially in environments with frequent code check-ins.

The systems and methodologies disclosed herein also reduce the maintenance overhead associated with large regression test suites. By focusing on the relevant tests, the need for maintaining extensive test sets is minimized. This streamlined approach ensures that only necessary tests are updated and maintained, which improves overall efficiency and reliability. Furthermore, targeting only the essential tests improves the reliability of the testing process by eliminating redundancy and overlap, thereby reducing the occurrence of false positives and false negatives. This targeted testing ensures more accurate and meaningful results, providing confidence that changes do not adversely affect the existing codebase.

Lastly, the dependency graph analysis employed in preferred embodiments of the systems and methodologies disclosed herein allows for the prioritization of the most critical and impactful tests. This ensures that the most important functionalities are thoroughly tested, reducing the risk of critical bugs being overlooked. By focusing on critical tests, the overall effectiveness of the regression testing process is enhanced.

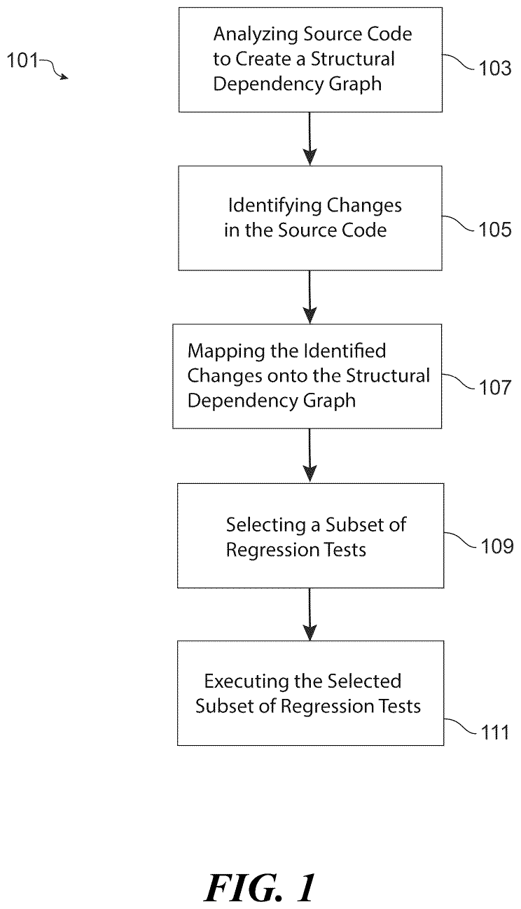

The systems and methodologies disclosed herein may be further understood with reference to FIG. 1, which depicts a first particular, nonlimiting embodiment of a method for optimizing regression testing in a software development environment in accordance with the teachings herein. This method 101 includes the steps of analyzing source code to create a structural dependency graph 103 that maps dependencies between code elements; identifying changes in the source code 105 between a current version and a previous version; mapping the identified changes onto the structural dependency graph 107 to determine affected code elements; selecting a subset of regression tests 109 based on the affected code elements identified in the dependency graph; and executing the selected subset of regression tests 111 to validate the changes in the source code. Each of these steps is described in greater detail below.

A. Analyzing Source Code to Create a Structural Dependency Graph that Maps Dependencies Between Code Elements

Analyzing source code to create a structural dependency graph involves several detailed steps that are important for optimizing regression testing. This graph visually represents the relationships and dependencies between various code elements, which helps in identifying specific areas of the codebase affected by changes. Initially, the source code is parsed to convert it into an intermediate representation that may be readily analyzed. Lexical analysis is employed to tokenize the code into manageable pieces called tokens, representing fundamental elements such as keywords, operators, identifiers, and literals. This is followed by syntactic analysis, which uses these tokens to construct an Abstract Syntax Tree (AST). The AST provides a hierarchical tree representation of the syntactic structure of the source code, where each node represents a construct such as, for example, a variable declaration, function call, or control structure.

Once the code is parsed and represented as an AST, the next step is to construct the dependency graph. In this graph, each node represents a distinct code element such as a variable, function, class, or method. Edges between nodes represent dependencies, such as function calls or variable usage. These edges help in understanding how changes in one part of the code may impact other parts. The graph preferably captures various types of dependencies, including data dependencies (where a piece of data in one part of the code is used or modified in another), control dependencies (where the execution of code depends on a condition evaluated elsewhere), and structural dependencies (such as inheritance in object-oriented programming).

Analyzing the graph to identify dependencies critical for regression testing involves examining both direct and transitive dependencies. Direct dependencies are straightforward links between code elements, while transitive dependencies are indirect links where a code element depends on another through a chain of direct dependencies. For example, if function A calls function B, and function B calls function C, then function A transitively depends on function C. Identifying these dependencies may be critical for comprehensive testing because changes can propagate through multiple layers of the code. By traversing the dependency graph, the impact of a change in one part of the code on other parts of the code may be determined, thus helping to prioritize which parts of the code should be retested after a change.

Visualization tools (such as, for example, Graphviz) may be utilized to create visual representations of the dependency graph, making it easier to understand and analyze the relationships between code elements. Interactive tools allow developers to explore the graph dynamically, zooming in on specific parts to examine detailed dependencies and their potential impacts. It is preferred that, as the codebase evolves, the dependency graph is continuously updated to reflect new changes. Incremental updates ensure that only the affected parts of the graph are updated, rather than reconstructing the entire graph from scratch. Integration with continuous integration and continuous deployment (CI/CD) pipelines ensures that the dependency graph is always up-to-date, providing accurate information for regression test selection.

### B. Identifying Changes in the Source Code Between a Current Version and a Previous Version

Identifying changes in the source code between a current version and a previous version is a critical step in optimizing regression testing. This process begins by detecting modifications, additions, and deletions in the code to understand how the codebase has evolved. Accurate identification of these changes helps to ensure that the most relevant tests can be selected and executed, thereby maintaining software quality while optimizing resource usage.

The first step in identifying changes involves integrating with version control systems (VCS) (these may include, for example, systems such as Git, SVN, or Mercurial). These systems track changes to the codebase over time, providing a comprehensive history of modifications, additions, and deletions. By comparing different commits, branches, or tags, the system may extract differences between code versions. Suitable tools (such as, for example, git diff) may be utilized to produce a list of changes, including modified lines, added or deleted functions, and other code alterations. The diff output provides a detailed line-by-line comparison of changes, highlighting additions and deletions, which is crucial for understanding the scope and impact of changes.

Changes in the source code may be categorized into three main types: additions, modifications, and deletions. Code additions include new elements such as functions, classes, variables, or modules added to the codebase. These additions need to be mapped to new nodes in the dependency graph to reflect their relationships with existing code elements. Code modifications involve alterations to existing elements which may include, for example, changes in function bodies, logic modifications, updates to variable values, or changes in method signatures. Modifications require updating existing nodes in the dependency graph to reflect the new state of the code and its dependencies. Code deletions involve the removal of existing elements from the codebase, necessitating the removal of corresponding nodes and edges in the dependency graph to maintain its accuracy.

Once the changes are identified, the next step is to map these changes onto the existing structural dependency graph to determine the affected code elements. Each identified change corresponds to specific nodes in the dependency graph. For example, if a function is modified, the node representing that function and its connections to other nodes (representing calls or data dependencies) are identified. When new code elements are added to the codebase, corresponding nodes are created in the dependency graph. Conversely, when code elements are deleted, their respective nodes are removed from the graph. This ensures that the dependency graph remains an accurate representation of the current codebase.

The edges connecting the changed nodes to other parts of the graph are examined and updated. For example, if a function is modified, all nodes that call this function or use its variables are identified, and their edges are updated to reflect the new dependencies. Similarly, when new dependencies are introduced (for example, a new function call), corresponding edges are added to the graph. When dependencies are removed (for example, a function call is deleted), the respective edges are removed from the graph.

Changes in the code may affect not only the directly modified elements but also other elements that depend on them. The dependency graph helps in identifying both direct and indirect dependencies. Direct dependencies are straightforward links between code elements, such as a function call or a variable usage. For example, modifying a function directly impacts the node representing that function and its immediate dependencies. The nodes directly associated with the change are updated to reflect the new state of the code, including properties such as method signatures, variable types, and other relevant details. Indirect dependencies involve cascading effects, impacting other nodes indirectly connected to the modified node. For example, if a widely-used function is changed, all functions and modules that call this function are potentially impacted. The system traverses the dependency graph to identify all nodes that are transitively dependent on the modified node, following the edges from the modified node through the graph to find all potentially affected nodes.

After mapping the changes onto the dependency graph, an impact analysis is performed to determine the extent of the changes and their potential effects on the codebase. By analyzing the dependency graph, the system propagates the impact of changes through the graph, following the edges from the modified nodes to all dependent nodes to determine how the changes affect other parts of the code. The system identifies critical paths within the dependency graph that are most likely to be affected by the changes. These paths represent sequences of dependent nodes that, if impacted, could cause significant issues in the software. Critical path analysis helps prioritize the areas of the code that require immediate attention and testing, ensuring that critical functionalities are tested first and reducing the risk of critical bugs going undetected.

For example, consider a scenario where a developer modifies the calculateTotal( ) function in an application. Using git diff, the system identifies that the calculateTotal( ) function has been modified. The dependency graph is updated to reflect this change, marking the node representing calculateTotal( ) and its edges to other functions that call or are called by it as impacted. All nodes directly calling calculateTotal( ) are identified and updated to reflect their direct dependencies on the modified function. The system then traverses the graph to find functions and modules that, while not directly calling calculateTotal( ) depend on its results or are part of a chain of calls starting from it. These indirect dependencies are also marked as impacted. The full impact of the modification is mapped out, showing all potentially affected parts of the codebase, and critical paths and nodes are identified, thereby prioritizing the areas that need to be retested.

Identifying changes in the source code between a current version and a previous version is essential for optimizing regression testing. By integrating with version control systems to detect modifications, additions, and deletions, and accurately mapping these changes onto a detailed dependency graph, the system may determine all affected code elements. This process ensures that only the relevant tests are selected for execution, significantly improving testing efficiency and effectiveness while reducing the associated time and cost.

C. Mapping the Identified Changes onto the Structural Dependency Graph to Determine Affected Code Elements

Mapping the identified changes onto the structural dependency graph is an important step in optimizing regression testing. This process ensures that modifications, additions, or deletions in the source code are accurately reflected in the dependency graph, allowing the system to determine which code elements are affected. After identifying changes in the source code (using, for example, tools such as git diff), these changes are mapped onto the existing structural dependency graph. Each identified change corresponds to specific nodes in the graph. For example, if a function is modified, the node representing that function and its connections to other nodes (representing calls or data dependencies) are identified. When new code elements are added, corresponding nodes are created in the graph, and when elements are deleted, their respective nodes are removed. This process keeps the graph accurate and up-to-date.

The edges connecting the changed nodes to other parts of the graph are then examined and updated. For example, if a function is modified, all nodes that call this function or use its variables are identified, and their edges are updated to reflect the new dependencies. New dependencies introduced (for example, a new function call) are added as edges in the graph, while removed dependencies result in the corresponding edges being deleted. This step ensures the integrity of the dependency graph, accurately representing the current state of the codebase.

Changes in the code may affect not only the directly modified elements but also other elements that depend on them. The dependency graph helps identify both direct and indirect dependencies. Direct dependencies are straightforward links between code elements, such as a function call or a variable usage. For example, modifying a function directly impacts the node representing that function and its immediate dependencies. Indirect dependencies involve cascading effects, impacting nodes indirectly connected to the modified node. For example, if a widely-used function is changed, all functions and modules that call this function are potentially impacted. The system traverses the dependency graph to identify all nodes that are transitively dependent on the modified node, following the edges from the modified node through the graph to find all potentially affected nodes.

After mapping the changes onto the dependency graph, an impact analysis is performed to determine the extent of the changes and their potential effects on the codebase. By analyzing the dependency graph, the system propagates the impact of changes through the graph, following the edges from the modified nodes to all dependent nodes to determine how the changes affect other parts of the code. The system identifies critical paths within the dependency graph that are most likely to be affected by the changes. These paths represent sequences of dependent nodes that, if impacted, could cause significant issues in the software. Critical path analysis helps prioritize the areas of the code that require immediate attention and testing, ensuring that critical functionalities are tested first and reducing the risk of critical bugs going undetected.

For example, consider a scenario where a developer modifies the calculateTotal( ) function in an application. Using sdiff, the system identifies that the calculateTotal( ) function has been modified. The dependency graph is updated to reflect this change, marking the node representing calculateTotal( ) and its edges to other functions that call or are called by it as impacted. All nodes directly calling calculateTotal( ) are identified and updated to reflect their direct dependencies on the modified function. The system then traverses the graph to find functions and modules that, while not directly calling calculateTotal( ) depend on its results or are part of a chain of calls starting from it. These indirect dependencies are also marked as impacted. The full impact of the modification is mapped out, showing all potentially affected parts of the codebase, and critical paths and nodes are identified, prioritizing the areas that need to be retested.

Mapping the identified changes onto the structural dependency graph is important for determining the affected code elements in a software system. By updating the nodes and edges to reflect changes, analyzing direct and indirect dependencies, and performing a thorough impact analysis, the system ensures that only the relevant tests are selected for execution. This targeted approach significantly improves the efficiency and effectiveness of regression testing, reducing time and costs while maintaining high software quality.

### D. Selecting a Subset of Regression Tests Based on the Affected Code Elements Identified in the Dependency Graph

Selecting a subset of regression tests based on the affected code elements identified in the dependency graph is important for optimizing the regression testing process. This step ensures that only the most relevant tests are executed, focusing on areas of the codebase impacted by recent changes. This targeted approach significantly improves testing efficiency and effectiveness while reducing resource usage and time.

The first step in selecting the appropriate subset of regression tests is analyzing test coverage data, which indicates which parts of the codebase are exercised by each test in the regression suite. Historical test coverage data from previous test runs is collected, including information about which functions, lines of code, and variables are covered by each test. Coverage tools (such as, for example, JaCoCo for Java, Istanbul for JavaScript, and Coverage.py for Python)) may be utilized to generate detailed coverage reports, instrumenting the code and tracking which parts are executed during test runs. Each test is then mapped to the specific nodes (code elements) in the dependency graph that it covers, creating a test-to-code map. This mapping is important for determining which tests are relevant to the affected code elements identified in the dependency graph.

Changes in the source code are mapped onto the dependency graph, identifying all affected code elements. These elements include both directly modified elements and those indirectly impacted through dependencies. The system propagates the impact of changes through the graph, marking nodes that are directly and transitively affected by the modifications. With the affected code elements identified, the system queries the coverage map to find all tests that cover these nodes, filtering out tests that do not cover any of the affected nodes. The remaining tests form the subset that will be executed, ensuring that only relevant tests, which are likely to reveal issues introduced by the recent changes, are selected.

If needed, the selected tests may be further prioritized based on various factors. Tests that have historically been effective at catching bugs may be given higher priority, as are tests that are quick to execute, providing faster feedback. Tests covering critical parts of the application, such as core functionalities or security-sensitive areas, may also be prioritized to reduce the risk of severe issues in production. The selected subset of regression tests is then executed to validate the changes. Parallel execution of tests may speed up the process, and resources may be allocated dynamically based on the subset of tests, optimizing computational resource usage and reducing costs.

For example, consider a scenario where a developer modifies the calculateTotal( ) function in an application. Historical test coverage data shows that testCalculateTotal( ) testOrderSummary( ) and testInvoiceGeneration( ) cover the calculateTotal( ) function and related elements. These tests are mapped to the nodes representing calculateTotal( ) and related functions in the dependency graph. When the calculateTotal( ) function is modified, the dependency graph is updated, and the impact of this change is propagated through the graph. The system queries the coverage map and identifies that testCalculateTotal ( ) testOrderSummary( ) and testInvoiceGeneration( ) cover the affected nodes. These tests are selected for execution, potentially in parallel, to validate the changes, ensuring that the modification did not introduce any new issues and that critical areas of the application are thoroughly tested.

### E. Executing the Selected Subset of Regression Tests to Validate the Changes in the Source Code

Executing the selected subset of regression tests is important to ensure that recent changes in the source code do not introduce new bugs or disrupt existing functionality. This process begins with preparing the testing environment by provisioning necessary resources such as virtual machines, containers, or cloud instances to create an isolated and production-like environment. Necessary software dependencies, libraries, and services are installed and configured, ensuring all components required for the tests are available. Configuration files and environment variables are set up to match the operational conditions of the application, including database connections and API keys.

The actual test execution involves running the selected subset of regression tests to verify that recent changes do not adversely affect the system. To speed up the process, tests may be run in parallel across multiple instances, reducing the overall time required for completion and providing faster feedback to developers. Tools such as Jenkins, GitLab CI, or Travis CI may be utilized to manage the test execution process, handling job scheduling, parallelization, and resource allocation. Real-time monitoring tools may be utilized to track the progress and performance of the tests, thus ensuring that any immediate issues are quickly identified and addressed. Detailed logs may be generated for each test run, capturing execution times, system states, and any encountered errors, which may be invaluable for diagnosing issues.

After executing the tests, the results are analyzed to determine the impact of the recent code changes. The results from all executed tests are collected and aggregated into a comprehensive report, which includes information on passed and failed tests, execution times, and any detected anomalies. Test artifacts such as screenshots, logs, and error reports may be included to provide detailed context for any test failures. Failed tests are flagged for further analysis, and the associated logs and artifacts are reviewed to understand the cause of the failure. The impact of test failures is assessed to determine their severity and prioritize the issues that need immediate attention.

Providing prompt and detailed feedback to developers is essential for quickly addressing any issues identified during testing. Automated alert systems inform developers of the test results, including summaries of passed and failed tests, along with links to detailed reports. A centralized CI/CD dashboard may be provided to facilitate real-time visibility into the status of the CI/CD pipeline, allowing developers to quickly review test outcomes and logs. Failed tests may be linked to issue tracking systems where detailed bug reports are created, including descriptions of the failure, steps to reproduce, and relevant logs or artifacts. Issues are prioritized based on their severity and impact, and then assigned to the relevant developers for resolution.

Continuous improvement is key to maintaining an effective testing process. Insights gained from test execution are used to refine the test suite, updating existing tests to cover new edge cases or improve robustness, and adding new tests to address identified gaps. Redundant tests that no longer provide value are removed to streamline the test suite. Developer feedback may be leveraged to help refine test selection criteria and improve test coverage, while machine learning algorithms can analyze historical test data to predict the relevance of tests more accurately, improving the efficiency of future test selections.

Various modifications and improvements may be made to the systems and methodologies disclosed herein without departing from the scope of the present disclosure. Some such modifications and improvements are described in greater detail below.

### 1. Context-Aware, Token-Database “Diff” Engine

In some embodiments, the disclosed regression-testing framework further incorporates a context-aware, token-database “diff” engine that refines how source-code modifications are detected and quantified. Unlike conventional line-oriented differencing utilities, the present engine operates on a normalized, language-agnostic token stream that is persisted, version-by-version, in a dedicated token database. By elevating the comparison granularity from raw characters to semantically meaningful tokens (and by enriching each token with lexical scope, data-flow, and control-flow metadata), the engine can distinguish substantive logic changes from benign, non-functional edits such as whitespace re-formatting or comment revisions. This discrimination materially reduces false-positive change detections and thereby prevents the regression-test selector from exercising needless test cases, leading to additional CPU-hour and cloud-spend savings on top of those achieved through dependency-graph analysis.

The token database preferably stores, for every build artifact, a canonical token sequence in which each token record contains: (i) a hash of the token lexeme, (ii) a fully-qualified syntactic context identifier (e.g., class::method scope in object-oriented languages), (iii) a semantic role flag (declaration, invocation, reference, literal, comment, etc.), (iv) a file-system path and commit identifier, and (v) an optional pointer to an interprocedural-dependency entry in the structural dependency graph. Persisting this metadata in columnar or graph form (e.g., Apache Parquet tables backed by an OLAP engine or Neo4j) enables high-throughput, set-based diff operations that scale to monorepos containing millions of lines of code across heterogeneous languages.

During a new build, the source code is re-tokenized using language-specific lexers and parsers, and the resulting token batch is bulk-loaded into a staging area. A two-phase differencing algorithm then executes:
A fast hash-based filter applies a rolling Rabin-Karp fingerprint across fixed-sized token windows to flag candidate change regions with O(n) complexity; and
A context reconciliation pass walks the flagged regions, comparing tokens only within identical syntactic envelopes (e.g., within the same function body or template specialization). This pass treats identifier renames, block re-ordering, and comment rewrites as cosmetic unless they alter control flow or data dependencies, as detected via incremental abstract-syntax-tree (AST) diffing.
   Tokens deemed materially changed are emitted as delta records that include their associated context identifiers. These context identifiers are already keyed into the structural dependency graph; consequently, the diff engine can hand off a compact changed-node list directly to the dependency-graph propagator. Because the list is scope-aware, downstream impact analysis can bypass large swaths of unaffected code, further shrinking the regression-test execution surface.

Integration with CI/CD tooling is facilitated through a streaming interface that publishes delta records to a message bus (e.g., Apache Kafka). As developers push commits, the diff engine updates the token database incrementally and streams newly affected context identifiers to the test-selection module in near-real time. This architecture supports short-lived feature branches and trunk-based development without imposing long blocking windows for full repository re-analysis.

The engine may be hosted on commodity x86 servers equipped with at least 32 GB of RAM for in-memory token-set operations; no GPU acceleration is required. For large enterprises, horizontal sharding of the token database and parallel execution of the hash-filter phase across worker nodes enable throughput on the order of hundreds of thousands of tokens per second, keeping pace with multi-team commit velocity.

Optionally, zero-diff compression is applied to unchanged token segments, and compact Bloom-filter sketches are cached to accelerate subsequent diff runs. Telemetry captured during operation (such as, for example, the ratio of cosmetic to substantive changes) feeds a feedback loop that tunes tokenization heuristics and hash-window sizes, incrementally improving diff accuracy and performance over time.

By coupling granular, context-rich differencing with the previously described dependency-graph analysis, the context-aware token-database diff engine provides a high-precision front end for regression-test minimization, ensuring that only those tests capable of surfacing true functional regressions are selected, while systematically filtering out noise introduced by non-functional edits.

### 2. Multi-Language Pipeline Via a Common Token Database

In preferred embodiments the regression-testing framework is language-agnostic at its core: all source artifacts, regardless of whether they originate from C++, Java, Python, JavaScript, or domain-specific languages such as SQL or VHDL, are funneled through a unified multi-language pipeline that normalizes code into a common token database. Each language is handled by a pluggable “ingestion adapter” that invokes a language-specific lexer/parser to produce a stream of canonical tokens—keywords, operators, identifiers, literals, and delimiters—that are already employed by the dependency-graph builder. The adapters emit tokens in a shared, versioned schema so that downstream components can treat every file as just another row set, irrespective of its original syntax.

To preserve language semantics while still enabling cross-language analysis, every token record carries (i) the raw lexeme hash, (ii) a language tag (e.g., LANG “py” or LANG “cpp”), (iii) a fully-qualified scope identifier that is namespaced by language conventions (e.g., Java package.class.method versus Python module.func), and (iv) a structural role flag derived from the language's AST (declaration, invocation, inheritance edge, etc.). Because the schema is superset-based, fields that are meaningless for a given language (such as generics metadata for Python) may be left null without breaking referential integrity. This organization lets the selective-test engine traverse mixed-language projects (such as a TypeScript front end that calls a Rust WebAssembly module) using a single SQL or graph query.

The pipeline executes in three stages. Stage 1 (Ingestion) tokenizes new or modified files in parallel, writing results into a staging partition. Stage 2 (Normalization) reconciles language-specific quirks (string-escape canonicalization, Unicode normalization, preprocessing directives) so that semantically equivalent constructs hash to the same value across languages. Stage 3 (Commit) merges the staging data into the production token tables and publishes Kafka events identifying the affected context IDs. Those IDs in turn feed the structural dependency graph and the context-aware diff engine described previously, enabling precise test minimization across heterogeneous codebases.

A chief advantage of the common token database is incremental extensibility. Adding support for a new language is as simple as supplying an adapter that maps the language's parser output into the shared schema; no other component needs to change. Moreover, analytics that were once language-bound (such as, for example, cyclomatic-complexity heuristics or secure-coding lint rules) can now be written once and applied uniformly, because they operate on the normalized token view rather than raw source files.

From an operational standpoint, the database is preferably backed by a columnar OLAP store (e.g., Apache Parquet on an object store fronted by DuckDB or Apache Druid) to sustain high-throughput bulk writes while still enabling sub-second ad-hoc queries. Commodity x86 servers with 64 GB RAM per node are sufficient for tokenizing and storing multi-million-line monorepos; no GPU acceleration is required. Where projects exceed that scale, horizontal sharding by repository or language tag allows near-linear scaling.

Consider a polyglot microservices application in which a Java service invokes a Python ML model and a Node.js API gateway. When a developer renames a data-transfer object in the Java layer, the ingestion adapter for Java records the renamed identifier and its scope. Because the DTO's serialized field names are detected in JSON schemas handled by the Node.js adapter, the normalization stage unifies the DTO reference across languages. The dependency graph therefore marks not only the Java microservice but also the gateway routes that consume the JSON payload as affected, ensuring that regression tests for both components are selected-even though the source languages differ.

By employing a single, scope-rich token database as the lingua franca beneath every language-specific adapter, the disclosed pipeline eliminates duplication, simplifies analysis logic, and ensures that regression testing remains both efficient and comprehensive in large, polyglot codebases.

### 3. Token-Level Coverage Metrics and Risk Scoring

In further preferred embodiments, the regression-testing framework augments its selective-test logic with token-level coverage metrics and a continuous risk-scoring engine. Unlike traditional line- or file-based coverage tools, the disclosed mechanism records execution evidence at the same normalized-token granularity employed by the common token database. Each token is therefore associated with a binary coverage bit (executed vs. not-executed during a given test run) and a floating-point risk weight that quantifies the probability that undetected defects in that token will propagate to user-visible failures. Persisting both measures alongside the token's lexical scope, commit identifier, and semantic role enables downstream analytics—such as test-selection heuristics and release-gate policies—to reason about quality gaps with sub-statement precision.

To generate the coverage bits, the build pipeline inserts lightweight instrumentation (e.g., compiler-level probes for compiled languages or byte-code injection for managed runtimes) that emits a token-ID and test-case ID pair whenever program control enters the syntactic span corresponding to that token. For interpreted languages (Python, JavaScript, Ruby), an AST rewriter wraps each statement in a decorator that records the token IDs nested inside the statement node. The emitted event stream is batch-committed to a coverage table keyed by (token-ID, test-case ID, build-ID), allowing incremental aggregation across nightly or per-commit test suites without redundant full-repository scans.

Risk weights are updated by a risk-scoring service that runs periodically, typically after every successful CI/CD cycle. For each token t, the service calculates a composite risk score

$${R}_{t} = α f Δ + β {d}_{h i s t} + γ {c}_{c o m p} + δ {g}_{c e n tral} , \qquad ( EQUATION 1 )$$

where the inputs represent:
fΔ: change frequency, modeled by an exponential decay of the time elapsed since the token's last modification;
dₕᵢₛₜ: historical defect density, i.e., the ratio of past bug-fix commits that touched the token's lexical scope;
c_{comp}: cyclomatic-complexity factor, reflecting the normalized complexity of the enclosing function or method;
g_{central}: dependency centrality, a PageRank-style measure within the structural dependency graph.
   The weighting coefficients α, β, γ and δ are learned or tuned over time so that Rₜ remains predictive of defect likelihood as the codebase evolves.

The service blends these inputs via a configurable weighted sum, optionally fine-tuned by a machine-learning model trained on prior release data. Tokens that exhibit both high risk and insufficient coverage are flagged as coverage gaps. The system emits gap events to the planning dashboard, where they can automatically (i) prioritize exploratory test generation, (ii) trigger code-review checklists, or (iii) block a release if a configurable risk-threshold is exceeded.

Since coverage and risk metadata are stored within the same OLAP-backed token database used for differencing, the context-aware diff engine can attach delta-risk deltas to its changed-node list: when a developer edits a high-risk, previously uncovered token, the diff engine escalates the affected-test priority and may recommend generating additional unit or property tests. Conversely, edits that only touch low-risk, well-covered tokens are ranked lower, enabling finer-grained balancing of CI execution time against defect-detection confidence.

In one illustrative embodiment, a monorepo containing 20 million tokens and 25 000 automated tests is processed nightly on a three-node x86 cluster, each node equipped with 64 GB RAM and NVMe scratch storage. Coverage ingest completes in under five minutes per node, and risk recomputation (leveraging vectorized SQL over Parquet partitions) finishes in less than 90 seconds. A real-time Kafka topic carries incremental coverage deltas back to IDE plugins, where developers receive instantaneous feedback on the risk-weighted coverage gap introduced by their current workspace edits.

Optionally, visual heat-maps rendered in the developer portal overlay source listings with color gradients proportional to Rₜ×(1−coverage), enabling rapid triage of brittle code regions. Telemetry collected across multiple projects feeds a federated learning back-end that continuously refines the weighting coefficients in the risk model, ensuring that risk scores remain predictive as codebases evolve.

By tracking execution at token resolution and coupling it with dynamic, data-driven risk estimation, the token-level coverage metric and risk-scoring subsystem delivers a precise, self-optimizing mechanism for focusing testing and review effort where it delivers the greatest quality return, thereby complementing—and amplifying—the benefits of the context-aware diff engine and the multi-language token pipeline previously described.

### 4. Partial-Run Coverage Merge Algorithm

In still further embodiments, the framework incorporates a partial-run coverage merge algorithm that reconciles token-level coverage evidence produced by successive, selective test subsets into a single, ever-green coverage corpus. Whereas the test-coverage analysis module already stores per-test execution data and maps it onto code-element nodes of the structural dependency graph, executing only a fraction of the full suite on each commit would normally leave large portions of the corpus flagged as “unknown.” The present algorithm eliminates this blind spot by treating each selective run as a delta against a canonical baseline bitmap maintained in the common token database described earlier.

At ingest time, every test shard emits a compact Roaring-bitmap sketch whose bit positions correspond one-to-one with token identifiers generated by the multi-language pipeline. The merge service first verifies shard completeness via monotonically increasing run-epoch numbers embedded in the bitmap header, then performs an idempotent bitwise-OR against the baseline bitmap. Because both structures are immutable once written, the operation achieves thread safety without locks; concurrent merges only append new column-store segments. A lightweight checksum-chain guards against torn writes, ensuring that partial updates from interrupted CI jobs are discarded rather than corrupting the baseline.

To prevent coverage staleness (tokens that were once executed but have since been refactored), the algorithm also maintains a token-generation vector keyed to the context-aware diff engine. Whenever the diff engine flags a token as modified or deleted, the corresponding bit in the baseline bitmap is cleared and its generation counter incremented. Subsequent selective runs must therefore re-cover the new token version before the overall coverage metric can return to green. This handshake guarantees that merged coverage never over-reports reality, even as the codebase evolves.

Since coverage bits alone do not express risk, every merge operation recomputes an incremental risk-adjusted coverage score for each token. The risk weight wₜ (derived from historical defect density, change frequency, and dependency-graph centrality) already resides next to the coverage bit. The merge service updates a running risk-exposed surface area metric

$$S = {\sum }_{t} ( {w}_{t} x ¬ {covered}_{t} ) \qquad ( EQUATION 1 )$$

in O(k) time, where k is the number of tokens touched in the current delta. The build pipeline can therefore promote artifacts only when S falls below a configurable threshold, even if the underlying test selection was partial.

To accommodate high-throughput CI environments where dozens of feature branches publish deltas concurrently, the merge algorithm executes in a streaming reducer tier backed by a Kafka topic that already carries token-level coverage events. Each reducer is responsible for a disjoint shard of the token-ID space and keeps its shard's bitmap in memory; writes are checkpointed to columnar Parquet files every minute. On typical x86 nodes with 32 GB RAM, a single reducer sustains more than 50,000 token updates per second, allowing a three-node cluster to merge coverage for monorepos exceeding 30 million tokens without backlog.

The algorithm further supports time-windowed roll-ups. Nightly jobs compute a seven-day trailing coverage view that feeds developer dashboards showing the percentage of freshly modified tokens executed within that window. Tokens whose generation counters have advanced but remain uncovered for more than N days trigger automatic work-item creation in the issue tracker, leveraging the feedback-loop facilities already present in the system.

Finally, a graceful degradation path ensures that if the aggregate uncovered-risk metric exceeds a hard ceiling (e.g., after a large refactor that invalidates many tokens), the scheduler escalates to a progressive widening strategy: it first schedules all low-cost smoke tests, merges their deltas, then schedules additional batches ordered by marginal risk reduction until the ceiling is met or the full suite has run. This adaptive widening minimizes cloud cost without compromising release safety, aligning with the overarching objective of selective yet trustworthy regression testing outlined in the parent disclosure.

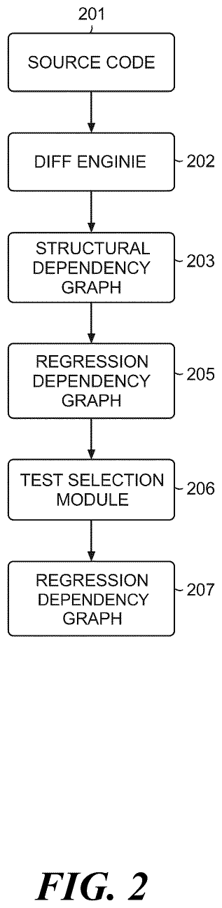

FIG. 2 illustrates a system architecture for regression test optimization in accordance with one embodiment of the present disclosure. The system begins with source code 201, which represents the current state of the software project, including its functional components and structural layout.

The diff engine 202 receives a prior version of the source code and compares it with the current version 201. The output of this process is forwarded to the diffing engine 203, which performs token-level and context-aware differencing. This engine identifies granular changes between code versions, excluding non-functional edits such as whitespace or comments.

The diffing output is used to update a structural dependency graph 204 that models relationships between code elements such as functions, classes, and modules. From this, a regression dependency graph 205 is derived, representing the subset of the system affected by recent changes.

A test selection module 206 receives the regression dependency graph 205 and uses historical coverage data, risk heuristics, or policy rules to identify a subset of regression tests that are most relevant to the impacted code.

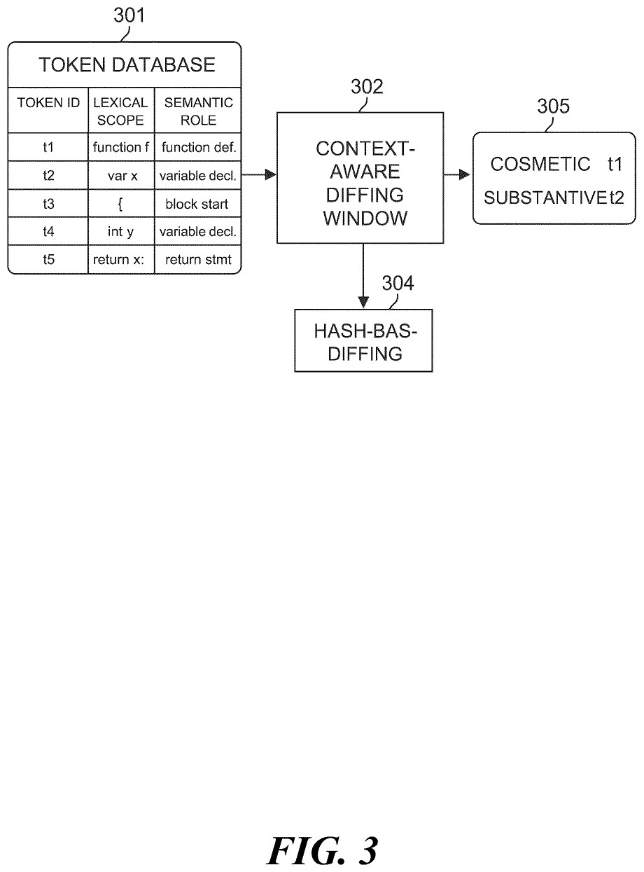

FIG. 3 illustrates an exemplary token-level differencing pipeline for regression test selection. The system includes a token database 301 that stores a set of versioned tokens extracted from source code. Each token record may include metadata such as token ID, lexical scope, semantic role, and commit identifier.

Token records from the database are streamed into a token differencing module 302, which comprises a hash-based diff window configured to rapidly detect changed regions of code. Within this module, lightweight hashing algorithms (e.g., Rabin-Karp rolling hashes) are used to flag candidate token windows exhibiting change.

Following the hash-based step, a context-aware diffing unit 303 performs deeper analysis of the changed tokens to determine whether a change is substantive (e.g., affecting logic, control flow, or data dependencies) or cosmetic (e.g., comment changes, formatting tweaks). This differentiation is used downstream to eliminate unnecessary regression tests that would otherwise be triggered by irrelevant edits.

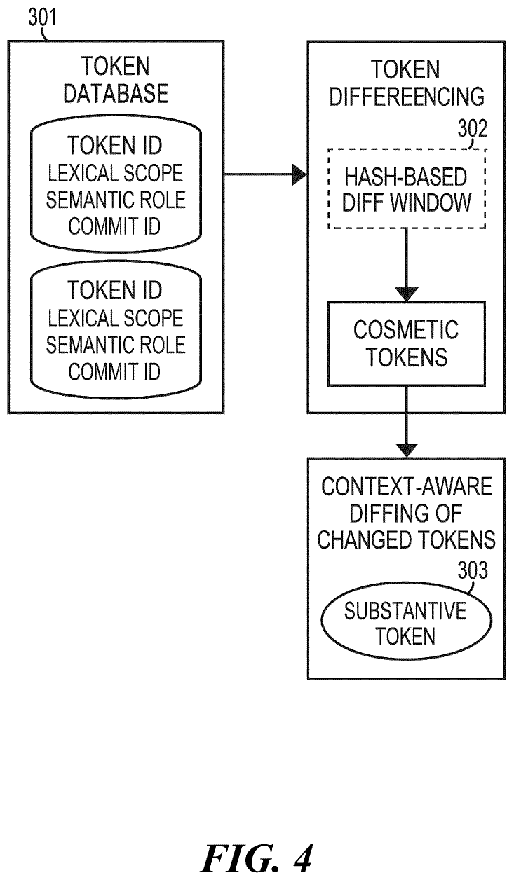

FIG. 4 illustrates another embodiment of a token differencing engine. A token database (301) is shown as a structured table storing entries with fields such as TOKEN ID, LEXICAL SCOPE, and SEMANTIC ROLE. Example tokens include variable declarations, function definitions, block delimiters, and return statements.

The table is connected to a context-aware diffing window 302, which receives a list of tokens and uses their semantic attributes and scope information to detect non-trivial changes. The diffing window is integrated with a hash-based differencing module 304 that assists in identifying candidate change regions with low computational overhead.

Outputs from the diffing process are routed to a token classification module 305 that assigns each token a label of either COSMETIC or SUBSTANTIVE, based on its role in program semantics. This classification enables selective test activation and minimizes false-positive test triggers caused by superficial edits.

The selected tests are passed to the test execution system 207, which may schedule them for execution in a CI/CD environment, cloud infrastructure, or local test runner. Results are reported back to developers, and may feed into further optimization cycles.

This architecture supports rapid, resource-efficient validation of incremental software changes while minimizing unnecessary test execution.

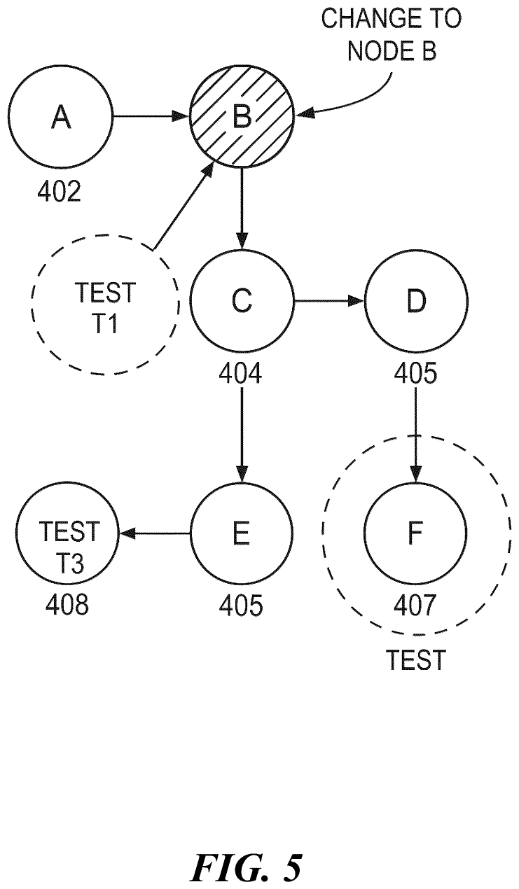

FIG. 5 illustrates a regression dependency graph 401 comprising a plurality of code element nodes and their structural relationships. Nodes 402 through 407 represent individual code components, such as functions, methods, or classes. Directed edges indicate dependency relationships between these elements. For example, NODE A 402 depends on NODE B 403, and NODE B in turn feeds into NODE C 404 and NODE D 405. Further downstream, NODE E 406 and NODE F 407 complete the graph.

NODE B 403 is visually distinguished with diagonal hatching, indicating that it has been recently changed. A labeled pointer 410 further identifies this update as a “CHANGE TO NODE B.” This change propagates through the dependency graph to other nodes that rely on it directly or transitively.

The diagram also includes TEST T1 408 and TEST T3 409 as dashed ovals, each representing regression test cases previously associated with specific subsets of nodes. For example, TEST T1 may cover NODES A, B, and C, while TEST T3 covers NODES D, E, and F. When a change is detected at NODE B, the system traverses the dependency graph and identifies that both TEST T1 and TEST T3 are potentially impacted and should be selected for re-execution.

This figure illustrates how the system ensures precise, impact-driven regression testing based on real-time dependency and coverage analysis.

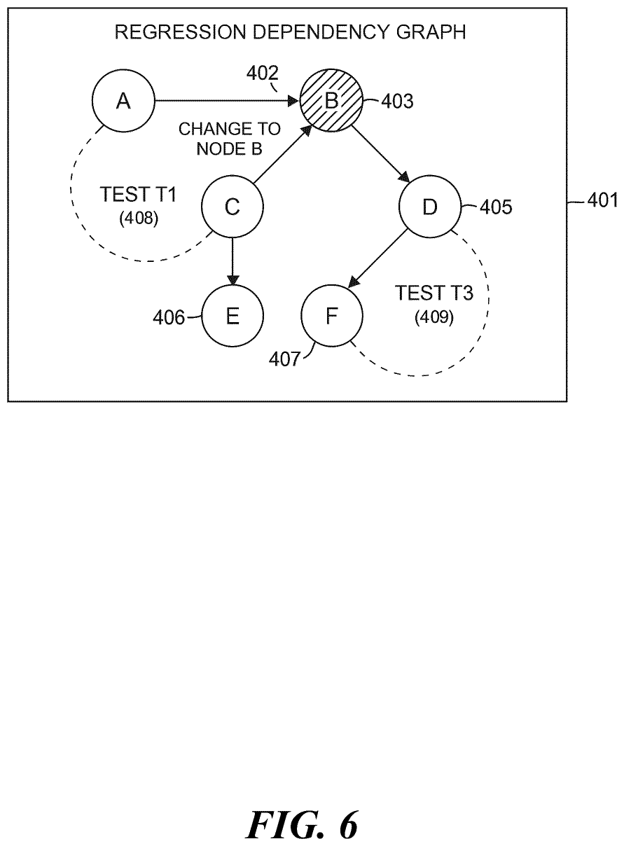

FIG. 6 illustrates a regression dependency graph 401 used to identify downstream impact from changes in a software codebase. The graph comprises nodes 402-407, where each node represents a code element such as a function, method, or class. NODE A 402 connects to NODE B 403, which is marked with diagonal hatching to indicate a recent modification.

From node B 403, dependencies propagate to NODE C 404 and NODE D 405, both of which subsequently influence other downstream nodes such as NODE E 406 and NODE F 407. These relationships are captured via directed edges that denote structural dependencies such as function calls or shared data access.

The diagram also shows TEST T1 408 and TEST T3 409, each represented by dashed ovals encompassing subsets of nodes. TEST T1 408 is associated with NODES A, B, and C, while TEST T3 409 corresponds to NODES D, E, and F. A visual label (“CHANGE TO NODE B”) illustrates that a source code change at node B may indirectly impact the execution behavior of downstream elements, thereby necessitating the re-execution of both T1 and T3.

This figure highlights how the system uses dependency-based propagation to target only relevant tests, avoiding full-suite execution and improving efficiency.

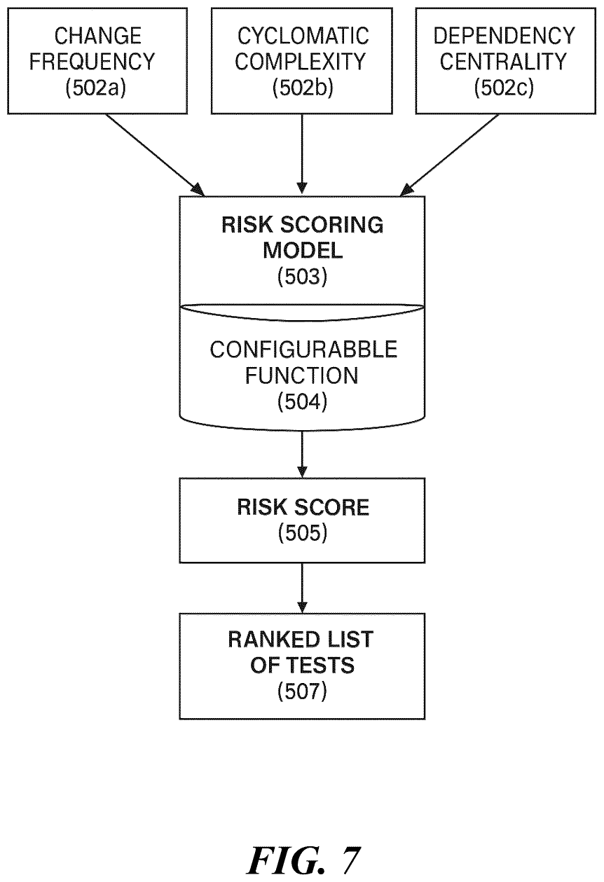

FIG. 7 illustrates a risk scoring architecture used to compute prioritization scores for regression test selection. Three input parameters (Change Frequency 502a, Cyclomatic Complexity 502b, and Dependency Centrality 502c) are shown as input boxes feeding into a central Risk Scoring Model 503. These inputs represent dynamically or statically computed metrics that quantify the volatility and structural importance of individual code elements.

The Risk Scoring Model 503 aggregates the input metrics using a configurable function 504, such as a weighted sum, machine learning model, or rule-based heuristic. The output of this model is a Risk Score 505, which may be computed for each token, method, or structural node in the dependency graph.

The bottom portion of the diagram includes two final outputs: a Risk Score 505 associated with each code element or token, and a Ranked List of Tests 507 sorted in descending order of relevance based on which code elements are exercised by each test. The system may use this ranked list to select a subset of tests for execution under resource constraints.

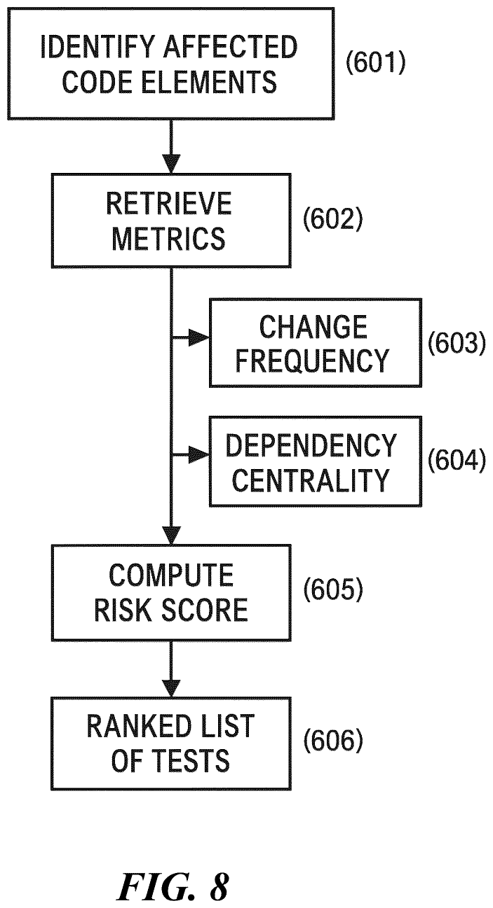

FIG. 8 shows a flowchart of a risk scoring and prioritization workflow used to inform regression test selection. The process begins at Identify Affected Code Elements 601, which identifies code units impacted by a recent change event (e.g., commit or merge).

The affected elements are passed to a Retrieve Metrics module 602, which collects associated metadata such as Change Frequency 603 and Dependency Centrality 604 from historical logs or static analysis. These metrics are fed into a Compute Risk Score module 605, which calculates a composite score indicative of how likely a change in the given code element may introduce a defect.

Each resulting Risk Score 605 is used to rank the regression test suite, favoring those tests that exercise high-risk code regions. The scoring logic may support weighting factors, exponential decay for temporal changes, or PageRank-style propagation through the dependency graph. This figure illustrates how the invention supports intelligent test selection by quantifying and leveraging software risk characteristics to drive resource-efficient validation strategies.

### TECHNICAL ADVANTAGES

The systems and methods disclosed herein confer numerous technical advantages over conventional regression testing frameworks. These advantages are not limited to algorithmic improvements, but rather constitute structural and architectural enhancements to the functioning of computing systems engaged in continuous integration and software deployment environments.

In particular, preferred embodiments of the systems disclosed herein materially improve computational efficiency through a token-level test filtering architecture that distinguishes substantive code changes from cosmetic or non-functional edits. By operating on semantically enriched token streams indexed within a versioned token database, the system avoids triggering unnecessary regression tests in response to innocuous edits such as comment revisions or code formatting changes. This significantly reduces the number of test cases that must be executed per commit, thereby decreasing total CPU-hours consumed during test runs.

Moreover, preferred embodiments of the systems disclosed herein accelerate continuous integration (CI) pipelines through risk-prioritized regression scheduling. By assigning dynamically computed risk scores to individual tokens based on historical defect density, change frequency, dependency centrality, and cyclomatic complexity, the system ensures that tests targeting high-risk and structurally critical code regions are prioritized. This enables rapid detection of potential regressions and improves software quality assurance timelines without necessitating full test-suite execution.

Further, preferred embodiments of the frameworks disclosed herein minimize cloud infrastructure costs by implementing selective autoscaling of compute resources. Regression tests are provisioned and executed in a cloud environment based on the computational demand of the selected subset of tests. The system dynamically adjusts the number and size of virtual machines, containers, or serverless workloads required to execute these tests, optimizing resource utilization and reducing runtime expenses under pay-per-use billing models typical of cloud service providers.

By integrating context-aware diffing, structural dependency graph propagation, and streaming test-selection updates (e.g., via Kafka), these embodiments of the disclosed system form an intelligent, self-optimizing regression testing pipeline that outperforms conventional solutions in terms of speed, accuracy, and cost-efficiency. These enhancements improve the functioning of computer systems engaged in software build, test, and deployment workflows, thereby satisfying critical demands in modern DevOps environments.

The above description of the present invention is illustrative and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

1-146. (canceled)

147. A method for optimizing regression testing in a software development environment, comprising:
analyzing source code to create a structural dependency graph that maps dependencies between code elements;
identifying changes in the source code between a current version and a previous version by performing a token-level differencing operation that compares sequences of semantically normalized tokens extracted from the source code;
mapping the identified changes onto the structural dependency graph to determine affected code elements;
selecting a subset of regression tests based on the affected code elements identified in the dependency graph; and
executing the selected subset of regression tests to validate the changes in the source code.

148. The method of claim 147, wherein the token-level differencing operation further comprises:
assigning each token to a syntactic context based on a fully qualified scope identifier; and
classifying changes as cosmetic or substantive based on the semantic role and syntactic context of the affected tokens.

149. The method of claim 147, wherein the identified changes and associated affected code elements are published as streaming delta records to a message bus configured to transmit the information to a test selection module in real time.

150. The method of claim 147, wherein the token-level differencing operation is performed on normalized token streams ingested via language-specific adapters, and wherein the normalized tokens are stored in a shared schema supporting cross-language dependency mapping.

151. The method of claim 147, further comprising computing a risk score for each affected code element based on at least one of:
change frequency, historical defect incidence, dependency centrality, and cyclomatic complexity;
wherein the regression tests are prioritized based on the computed risk scores of the elements they cover.

152. The method of claim 147, further comprising maintaining a canonical token-level coverage bitmap across regression test runs and merging new test coverage results by performing a bitwise operation on token identifiers associated with executed code regions.

153. The method of claim 147, wherein analyzing source code to create a structural dependency graph comprises:
tokenizing the source code to generate tokens representing fundamental elements therein; and
constructing an abstract syntax tree (AST) from the tokens to represent the hierarchical structure of the code.

154. The method of claim 153, wherein the fundamental elements are selected from the group consisting of keywords, operators, and identifiers.

155. The method of claim 147, wherein identifying changes in the source code between a current version and a previous version comprises:
integrating with a version control system (VCS) to track changes to the codebase; and
using a tool to produce a list of changes, wherein the changes are selected from the group consisting of modified lines, added or deleted functions, and other code alterations.

156. The method of claim 147, wherein mapping the identified changes onto the structural dependency graph to determine affected code elements comprises:
updating nodes in the dependency graph to reflect changes in the code, wherein the changes are selected from the group consisting of modifications, additions, or deletions of functions, classes, or variables; and
updating edges in the dependency graph to reflect changes in dependencies between code elements.

157. The method of claim 147, wherein selecting a subset of regression tests based on the affected code elements identified in the dependency graph comprises:
analyzing historical test coverage data to determine which tests cover the affected code elements; and
filtering out tests that do not cover any of the affected code elements to form the subset of relevant regression tests.

158. The method of claim 147, further comprising prioritizing the selected subset of regression tests based on factors selected from the group consisting of historical effectiveness at catching bugs, execution time, and coverage of critical parts of the application.

159. The method of claim 147, wherein executing the selected subset of regression tests to validate the changes in the source code comprises:
provisioning necessary resources to create an isolated testing environment; and
running the selected tests in parallel to reduce the overall time required for completion.

160. The method of claim 159, wherein the resources include virtual machines, containers, and cloud instances.

161. The method of claim 147, further comprising collecting and aggregating the results of the executed tests into a report, wherein said report includes (a) information on passed and failed tests, (b) execution times, and (c) detected anomalies.

162. The method of claim 147, further comprising:
providing automated notifications to developers with summaries of test results, including links to detailed reports; and
integrating the test results with issue tracking systems to create detailed bug reports.

163. The method of claim 147, further comprising:
continuously updating the structural dependency graph as the codebase evolves, ensuring that the graph accurately reflects the current state of the code; and
integrating the updated dependency graph with continuous integration/continuous deployment (CI/CD) pipelines to provide accurate information for regression test selection.

164. The method of claim 147, wherein the method is executed by at least one processor configured to perform each of the recited steps.

165. The method of claim 147, further comprising storing the structural dependency graph in memory accessible to the processor, and updating the graph in response to source code changes detected by a version control system.
